(19) United States
(12) Patent Application Publication
(10) Pub. No.: US 2026/0275636 A1
(43) Pub. Date: Sep. 17, 2026

(54) CEILING BASEMAT WATER REDUCTION THROUGH STRATEGIC USE OF PRESSING AND VACUUMING

(71) Applicant: USG INTERIORS, LLC, Chicago, IL (US)

(72) Inventors: Yufeng XU, Gurnee, IL (US); Ashish DUBEY, Grayslake, IL (US); Jimmy Irby JACKSON, II, Greenville, MS (US); Ryan Charles ASHLEY, Greenville, MS (US); Zachary Reed Higginbotham, Montrose, AK (US); William Allen FRANK, Lake Villa, IL (US); Timothy Joe MILLER, Mundelein, IL (US)

(21) Appl. No.: 19/079,643

(22) Filed: Mar. 14, 2025

(51) Int. Cl. D21F 1/52; D04H 1/4218; D04H 1/425; D04H 1/4382; D04H 1/492; D04H 1/587; D21F 3/02; D21F 9/02; D21H 13/40; D21H 17/28; D21H 17/68

(52) U.S. Cl. CPC D21F 1/52; D04H 1/4218; D04H 1/425; D04H 1/43835; D04H 1/492; D04H 1/587; D21F 3/0272; D21F 9/02; D21H 13/40; D21H 17/28; D21H 17/68; D10B 2503/00

(57) ABSTRACT

Water-felting systems and methods with significant energy savings and carbon emission reduction for producing ceiling tiles with improved green strength, the methods including: felting a green ceiling basemat on a foraminous wire conveyor; drawing water out the green ceiling basemat by free drainage; compressing the green ceiling basemat with a first press to a first caliper; compressing the green ceiling basemat with a second press to a second caliper, the second caliper being the final caliper for the green ceiling basemat; after the final caliper has been achieved with the second press, drawing water out the green ceiling basemat by applying suction generated with one or more vacuum boxes operably connected to a set of vacuum pumps; and drying the green ceiling basemat in a dryer.

### TECHNICAL FIELD

This disclosure relates to building construction materials and their manufacturing methods with significant energy savings and carbon emission reduction by which a ceiling tile with improved green strength can be produced.

### BACKGROUND

A water-felting method can be used for manufacturing ceiling tiles, including as described in U.S. Pat. Nos. 10,696,594 and 8,801,902. In a water-felting method, an aqueous slurry comprising fibers, binder and some other additives is felted on a moving foraminous wire conveyor into a green ceiling basemat which is step-by-step dewatered and pressed to a particular caliper. After processing on the conveyor is completed, a resulting wet green ceiling basemat may still contain a significant amount of water, e.g. 69-70 wt % water. Water is then removed by drying the wet green ceiling basemat in a heated convection drying oven.

Current methods include those in which a green ceiling basemat may have a water load on a dryer of 1300-1550 pounds, depending on the product formulation and thickness. The water load is an amount of water in each one thousand square feet of the green ceiling basemat that needs to be evaporated in a dryer.

With increasing awareness of global warming, there is a strong need in the field for improved water-felting methods, which dewater green ceiling basemat more efficiently on a conveyor, but without deforming or cracking it, such that a water load on a dryer may be decreased, saving energy and lowering carbon emission.

### SUMMARY

Objectives of this disclosure include providing ceiling tile manufacturing methods and systems with significant energy savings and carbon emission reduction, including methods in which a green ceiling basemat of improved green strength is produced with a decreased water load on a dryer.

In one aspect, this disclosure relates to a method for continuous manufacturing of a ceiling tile by a water-felting process, the method comprising:
a) felting an aqueous slurry comprising fibers, perlite, and a binder into a green ceiling basemat on a foraminous wire conveyor;
b) drawing water out the green ceiling basemat by free drainage;
c) after step b), drawing water out the green ceiling basemat by applying suction generated with one or more vacuum boxes operably connected to a vacuum fan;
d) after step c), compressing the green ceiling basemat with a first press to a first caliper;
e) after step d), compressing the green ceiling basemat with a second press to a second caliper, the second caliper being the final caliper for the green ceiling basemat;
f) after step e), drawing water out the green ceiling basemat by applying suction generated with one or more vacuum boxes operably connected to a set of vacuum pumps; and
g) drying the green ceiling basemat in a dryer.

Preferred embodiments of the method may include those in which no vacuum box generated suction is applied to the green ceiling basemat between the first and second presses. Some embodiments of the method may comprise calendaring the green ceiling basemat with a calendar wherein the calendar is set to the same caliper as the second press, and optionally, further drawing water out the green ceiling basemat by applying suction generated with a vacuum box operably connected to the set of vacuum pumps after calendaring.

Preferably, the green ceiling basemat after step f) may have a reduced water load on the dryer in step g) in comparison to a control green ceiling basemat that was compressed to a final caliper with a calendar.

In some embodiments of the method, the water load on the dryer may be reduced by at least 5 wt %, 10 wt %, 15 wt %, 20 wt %, 25 wt %, or at least 30 wt %.

Some embodiments of the method may further comprise: after step f) and before step g), cutting the green ceiling basemat into master panels; and after step g), cutting the master panels into ceiling tiles. These embodiments may include perforating, coating and/or laminating the ceiling tiles.

Preferred embodiments of the method include those, wherein step c) comprises passing the green ceiling basemat through at least six vacuum boxes operably connected to the vacuum fan.

In preferred embodiments, the final caliper of the green ceiling basemat may range from about 0.5 to about 1.0 inches.

In some method embodiments, the vacuum fan may operate in a range of 1.5 to 6 inch mercury (inHg) and/or the set of vacuum pumps may operate in a range of 6 to 20 inch mercury (inHg). Optionally, the set of vacuum pumps may comprise two or three pumps.

In some embodiments, the slurry comprising all formulation components may be a 3 to 8 wt % aqueous suspension at the headbox and initiation of the wet-felting process.

In another aspect, this disclosure relates to a manufacturing system for performing the method according to this disclosure, wherein the system comprises:
a headbox for discharging a slurry;
a foraminous wire conveyor having a foraminous wire screen surface movable in a horizontal direction, the foraminous wire conveyor comprising:
   i) a forming table;
   ii) a free drainage section;
   iii) a low-vacuum section comprising two or more vacuum boxes operably connected to a vacuum fan configured to lower pressure in the two or more vacuum boxes;
   iv) a high-vacuum section comprising:
      a first press and a second press positioned after the first press in the direction of the conveyor surface movement,
      at least two, preferably 3 to 8, more preferably 3 to 6, and most preferably 3 to 5, vacuum boxes positioned consecutively after the second press in the machine direction, each of said vacuum boxes being sealed under the surface of the conveyor, wherein each of said vacuum boxes is operably connected to a set of vacuum pumps through a switch-regulated conduit, and
      a dryer.

In preferred embodiments of the manufacturing system, the manufacturing system may further comprise a cutting knife section positioned after the high-vacuum section, relative to the direction of the conveyor surface movement. Preferably, the high-vacuum section may comprise 3 to 5 vacuum boxes operably connected to the set of vacuum pumps. Preferably, embodiments of the manufacturing system may include those in which the high-vacuum section of the manufacturing system may further comprise a calendar with adjustable caliper; and a vacuum box positioned after the calendar relative to the direction of the conveyor surface movement, the vacuum box operably connected to the set of vacuum pumps.

In another aspect, this disclosure relates to a ceiling tile produced by the methods according to this disclosure and preferably in the methods practiced with the system accordingly to this disclosure, wherein the green ceiling basemat has a water load on a dryer of less than 1250 pounds per one thousand square feet, and more preferably less than 1150 pounds per one thousand square feet, and most preferably less than 1050 pounds per one thousand square feet.

### BRIEF DESCRIPTION OF THE DRAWINGS

FIG. 1 is a flowchart of one embodiment of a water-felting method according to this disclosure for producing a ceiling tile with increased green strength and decreased water load.

FIG. 2A is a schematic side view of one embodiment of a manufacturing system for producing a ceiling tile in a water-felting method according to this disclosure.

FIG. 2B is a perspective view of one embodiment of a vacuum box according to this disclosure.

FIG. 3A is a schematic cross-sectional view of a green ceiling basemat, as per a conventional method. Arrows denote the direction in which vacuum suction is applied through the green ceiling basemat thickness.

FIG. 3B is a schematic cross-sectional view of a green ceiling basemat to which vacuum suction is to be applied according to this disclosure after a green ceiling basemat was compressed to a final caliper. Arrows denote the direction in which vacuum suction is applied through the green ceiling basemat thickness.

FIG. 4 is a schematic top-down cross-sectional view of one embodiment of a vacuum suction set according to this disclosure, including three vacuum pumps operably connected to vacuum boxes 7-11 in the high-vacuum section, each vacuum box being connected with a switch-regulated conduit.

### DETAILED DESCRIPTION

In this disclosure, “wt %” means percentage by weight. In this disclosure, all percentages and ratios are by weight, unless specifically stated otherwise.

In this disclosure, “lbs/MSF” refers to pounds per one thousand square feet and “lbs/SF” refers to pounds per square foot.

In this disclosure, “dry component” means that the component is a solid substance, and it does not comprise aqueous water or liquid additives. The dry component may have some moisture content and may contain bound water molecules. Examples of dry components include mineral wool, glass fibers, paper fibers, expanded perlite, starch, clay, etc.

In this disclosure, “by wt % on a dry basis of the composition” means by weight of dry components, not including aqueous water or liquid components.

In this disclosure, “about” means plus/minus 10% of a specified numeric value, e.g., “about 100” means 100±10 and “about 200” means 200±20.

In this disclosure, all steps in claimed methods are operated at room temperature unless other temperature is specified for a step. In this disclosure, the “room temperature” is defined as comfortable ambient temperature ranging between 59° F. and 78° F.

In this disclosure, one inch of mercury (inHg) is a unit of measurement of pressure. One inch mercury (inHg) is equal to 3386.39 Pascals at 32° F. (0° F.). Perfect vacuum (complete absence of pressure) is defined as 29.92 inHg. The sale starts at 0 inHg (atmospheric pressure, no vacuum) and goes up to 29.92 inHg (perfect vacuum, zero atmospheric pressure).

In this disclosure, a “green” ceiling basemat means a ceiling basemat which has not been dried in a dryer, and which may comprise a significant amount of water.

In this disclosure, a “green” strength means the strength of the green ceiling basemat prior to being dried in a dryer.

In this disclosure, “water load” means an amount of water by weight in each one thousand square feet of a green ceiling basemat that needs to be evaporated in a dryer.

In one aspect, this disclosure relates to water-felting methods for manufacturing ceiling tiles. The water-felting method according to this disclosure may be used for manufacturing a green ceiling basemat with increased green strength and decreased water load on a dryer. Thus, the disclosed herein water-felting methods provide significant energy savings and reduction in carbon emission. In some embodiments, carbon emission may be reduced by at least 5%, at least 10%, at least 15%, at least 20%, at least 25%, or at least 30% in comparison to a conventional water-felting method.

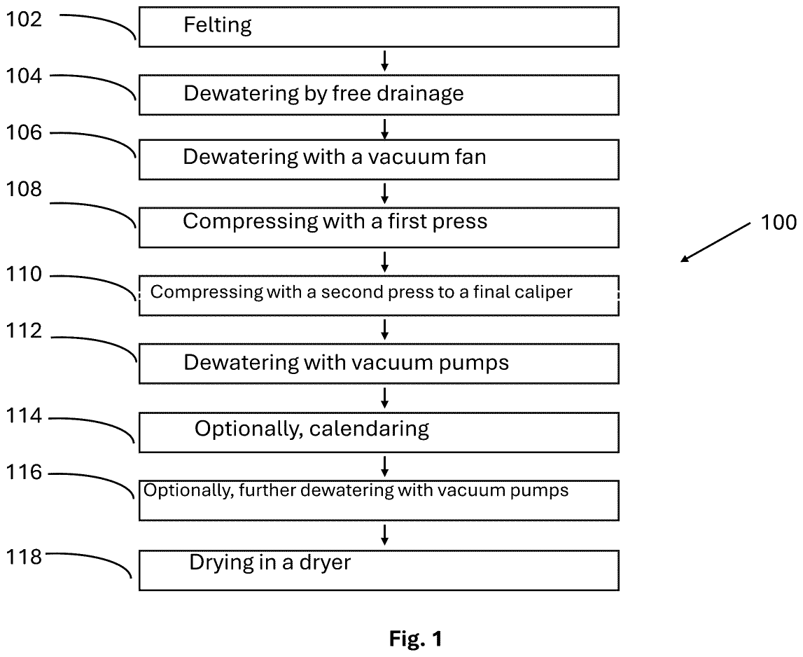

With reference to FIG. 1, a water-felting method according to this disclosure, generally (100), may comprise steps (102) through (118).

In step (102), an aqueous slurry comprising fibers, perlite, binder and one or more additives is felted into a green ceiling basemat on a foraminous wire conveyor. Typically, water slurries may comprise from about 92 to up to about 97 or even up to about 99 wt % water. Thus, significant dewatering is required to remove water from the forming green ceiling basemat. In the present methods, dewatering is accomplished in several steps.

In step (104), water is removed from the green ceiling basemat by free drainage, preferably through perforations in a wire-screen surface of the conveyor.

In step (106), more water is removed from the green ceiling basemat by applying suction generated with a vacuum fan. At this stage, the formed web comprising green ceiling basemat is still fragile and therefore weak pressure (“low pressure” or “low-vacuum”) must be applied in order not to excessively disturb and/or damage the formed green ceiling basemat. Thus, suction is provided by employing a vacuum fan instead of using a vacuum pump. In preferred embodiments, the vacuum fan can be operated at 6 inch mercury (inHg) or less. For example, from about 1 to about 6 inHg, more preferably from about 1.5 to about 4 inHg, and most preferably from about 2.0 to about 4 inHg. Suction can be applied through one or more vacuum boxes operably connected to one or more vacuum fans.

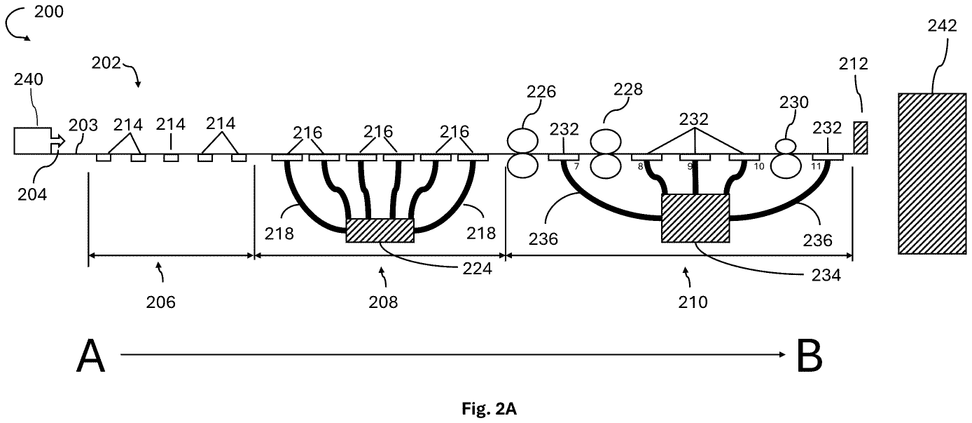

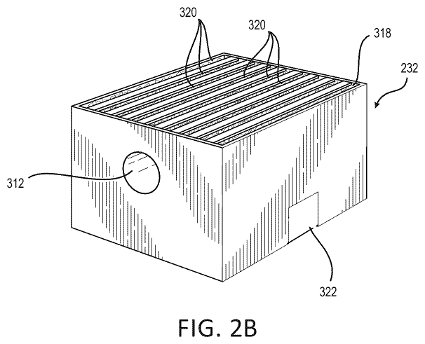

A vacuum box (232), one embodiment of which is shown in FIG. 2B, is a chamber, which can be made of steel or some other suitable material. The vacuum box (232) has a vacuum outlet (312) on one of its side walls. The vacuum box (232) may be connected to a vacuum fan or a vacuum pump through the vacuum outlet (312), creating negative pressure in the vacuum box (232) when the vacuum fan or the vacuum pump is in operation. The vacuum box (232) has a suction panel (318) at its top surface in the drawing of FIG. 2B. The suction panel (318) comprises a plurality of slots or some other perforations (320) through which water can be suctioned into the vacuum box (232) and then removed from the vacuum box (232) through a water removal outlet (322) in a sidewall of the vacuum box (232), when the water removal outlet (322) is connected to a pipe (not shown). The suction panel (318) is attached, preferably removably, to the vacuum box (232). When in operation, the vacuum box (232) may be positioned under the foraminous wire conveyor with the suction panel (318) being in a sealed contact with the foraminous conveyor surface such that when a green ceiling basemat is positioned over the vacuum box (232) while moving on the foraminous wire conveyor, suction may be generated which draws the water out of the green ceiling basemat through the conveyor's perforations and the slots (320) of the vacuum box (232) into the vacuum box (232) such that water can be collected at the bottom of the vacuum box (232) below the level of the vacuum outlet (312) and removed from the vacuum box (232) through the water outlet (322) connected to a pipe (not shown). The water can then be recycled. Preferably, the water outlet (322) is positioned lower than the vacuum outlet (312) on the sidewall, relative to the suction panel (318).

After completing the dewatering step (106), the green ceiling basemat is compressed to decrease its caliper (thickness). In the methods according to this disclosure, the compression of the formed green ceiling basemat is accomplished stepwise.

First, in step (108), the green ceiling basemat is compressed to a first caliper with a first press. In embodiments, the first press may be a cylindrical twin-roll press (226), preferably a vacuum twin-roll press such that the green ceiling basemat is pressed between the two rolls. These rolls can be made of metal, engineered plastic, or rubber. The press roll can optionally be perforated to facilitate removal of additional water from the green ceiling basemat upon application of the mechanical pressure. In some other embodiments, the mechanical pressure can be supplemented by a vacuum applied to one or both rolls of the twin-roll press (226) to facilitate removal of additional water. In some preferred embodiments, a caliper of the green ceiling basemat after the first press (226) may be in the range of about 0.60 to about 1.00 inches, but a green ceiling basemat of other thickness can be also produced.

Second, in step (110), the green ceiling basemat is further compressed to a second and final caliper with a second press which in embodiments may be also a second twin-roll press and more preferably a second vacuum twin-roll press (228). Suction by vacuum box may optionally be applied to the green ceiling basemat between the first and second presses. Furthermore, it has been unexpectedly found that pressing the green ceiling basemat in the second press to the green ceiling basemat final caliper instead of pressing to the final caliper in the calendar press as was previously done in conventional methods, provides certain technically advantages, including 1) more efficient dewatering by which more water is removed from the green ceiling basemat prior to its drying in a dryer; and 2) producing a green ceiling basemat with less cracking and fewer defects in the green ceiling basemat structure.

In preferred embodiments, the final caliper of the green ceiling basemat after the second press (228) may be reduced by about 0.20 inches, at least by about 0.15 inches, at least by about 0.10 inches, or at least by about 0.05 inches in comparison to the conventional water-felting method where the final caliper of the green ceiling basemat is achieved at the calendar (230).

In some preferred embodiments, the final caliper of the green ceiling basemat after the second press may be in the range from about 0.50 to 0.90 inches, preferably about 0.60 to 0.65 inches, more preferably about 0.70 to 0.75 inches, or preferably about 0.75 to 0.80 inches, or preferably about 0.80 to 0.85 inches, but a green ceiling basemat of other thickness can be also produced.

It has been unexpectedly found that compressing the green ceiling basemat to its final caliper with the second press and before applying a majority of the vacuum suction with vacuum pumps improves the green strength of the green ceiling basemat and increases the amount of water that can be subsequently drawn out from the green ceiling basemat with vacuum pumps such that a water load on a dryer may be decreased.

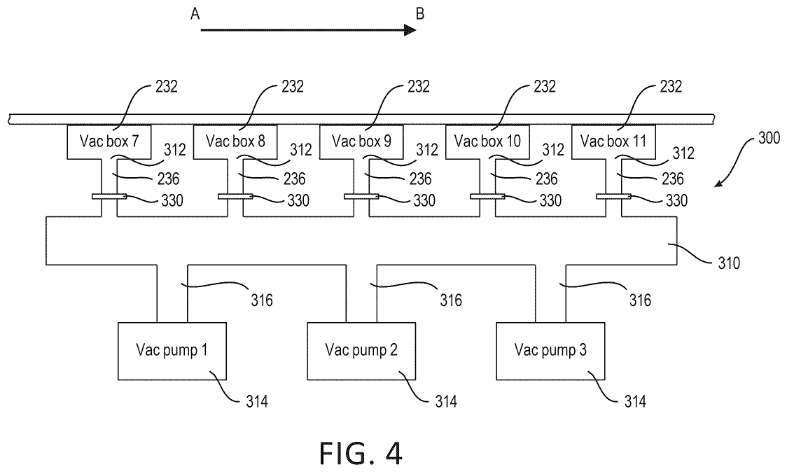

After compressing to the final caliper is accomplished with the second press, step (112) is performed in which water is drawn out the green ceiling basemat having the final caliper by applying suction generated with one or more vacuum boxes (232) operably connected to a set of vacuum pumps (234), one embodiment of which is shown in FIG. 4. These vacuum boxes (232) are connected to a set of vacuum pumps (234), and they apply a stronger pressure (“high-vacuum” or “high pressure”) relative to the lower pressure (“low-vacuum”) as was applied with a vacuum fan in step (106). In some preferred embodiments, the set of vacuum pumps (234) can operate in the range of about 6 to 20 inch mercury (inHg), preferably 7 to 18 inch mercury (inHg), more preferably in the range of about 8 to 16 inHg, and most preferably in the range of 9 to 15 inHg.

In step (114), the green ceiling basemat may be optionally smoothened with a calendar (300) wherein the calendar operates at the same caliper as the second press such that the final caliper of the green ceiling basemat does not change while being calendared. Some embodiments of the method (100) may be performed without using the calendar (300).

In step (116), the green ceiling basemat may further optionally dewatered by drawing water out with suction generated in a vacuum box (232) connected to a vacuum pump. In some embodiments, this vacuum box (232) can be connected to the same set of pumps as used in step (112).

In step (118), the green ceiling basemat is dried in a drying oven (dryer) which may be preferably a heated convection oven which in embodiments, can be operated at a temperature as high as 550° F. at the beginning of the drying step (118). The temperature may be gradually decreased to 200-250° F. at the end of the drying step (118). In some embodiments, the oven may have several different drying zones with a temperature being highest in a first drying zone and then gradually decreasing as the green ceiling basemat is moving from the first drying zone to the second drying zone. In some embodiments, the oven may have three drying zones, including as was described in U.S. Pat. No. 5,911,818. In zone 1, the temperature at the beginning may be about 400° F. and gradually increasing to 650° F. In zone 2, the average temperature may be about 550° F. The temperature in zone 3 may be averaging 350° F. and gradually decreasing to 200-250° F.

In some embodiments, the method (100) may further comprise a step of cutting the green ceiling basemat into master panels before drying in a dryer and a step of cutting the master panels into ceiling tiles after the master panels are dried in the dryer of step (118).

In some embodiments, the method (100) may further comprise one or more of the following steps after step (118), cutting the master panels into ceiling tiles, cutting edges of the ceiling tiles, perforating, surface grinding, roll/spray coating and/or laminating the ceiling tiles onto a scrim or screen, including as was described in U.S. Pat. No. 10,094,614.

It has been unexpectedly found that the water-felting method (100) of this invention provides several technical advantages, including it dewaters a green ceiling basemat more efficiently and also produces a green ceiling basemat with stronger green strength in comparison to a green ceiling basemat produced in conventional method in which the final caliper of the green ceiling basemat is achieved only with a calendar.

Direct benefits of the method (100) include significant energy savings and reduction in carbon emission which in embodiments may be reduced by 10% or more, because green ceiling basemats produced in the method (100) contain less water and therefore can be dried in a dryer quicker or at a lower temperature such that less energy is needed to operate the dryer before a dried ceiling basemat is obtained. The present method also reduces web breakage and dryer jams, thereby increasing the production recovery from the dryer as well as decreasing the machine downtime. Furthermore, as the green strength of the green ceiling basemat is increased in the method (100), it is possible to formulate a slurry for felting with recycled materials, such as when recycling off-quality ceiling tiles or broken ceiling tiles which can be first ground into a powder and then included into a slurry.

Preferred embodiments of the method (100) may be performed with a continuous manufacturing system, a side view of one embodiment of which, generally (200), is shown in FIG. 2A.

The manufacturing system (200) includes a headbox (240), a foraminous wire conveyor (202) connectable to a motor (not shown) and a dryer (242). The foraminous wire conveyor (202) includes a conveyor belt with a foraminous wire screen surface with perforations (203) movable in a horizontal direction A to B over a series of rollers (not shown) powered by the motor (not shown) such that the rollers can rotate and move the foraminous wire screen surface (203), in the direction A to B. The direction A to B can be referred in this disclosure as the machine direction.

The foraminous wire conveyor (202) comprises: a forming table (204), followed by a free-drainage section (206), followed by a low-vacuum section (208), followed by a high-vacuum section (210) and a cutting knife section (212), all relative to the machine direction A to B.

An aqueous slurry comprising fibers, perlite, a binder and one or more additives may be continuously mixed in a mixer (not shown) and deposited into the headbox (240) which is a receptacle configured for agitating and continuously discharging the aqueous slurry onto the forming table (204). As the aqueous slurry is moving on the conveyor (202) in the machine direction, preferably with agitation, the slurry felts by forming an interconnected web of fibers into a green ceiling basemat (ribbon) while water being continuously removed in the free-drainage section (206).

The free-drainage section (206) contains one or more water drainage conduits (214) positioned under the foraminous wire screen surface (203) for collecting and recycling water.

As the green ceiling basemat continues moving on the conveyor (202), the green ceiling basemat enters the low-vacuum section (208) of the conveyor (202). The low-vacuum section (208) contains one or more vacuum boxes (216) connected by conduits (218) to a vacuum fan (224). The vacuum boxes (216s) are positioned under the conveyor surface (203). The vacuum boxes (216s) are positioned consecutively, relative to the machine direction.

In the embodiment of FIG. 2A, six vacuum boxes (216) are shown, but the number of vacuum boxes (216) may be increased or decreased, depending upon the processing needs. In the embodiment of FIG. 2A, all vacuum boxes (216) are connected to the same vacuum fan (224). In some other embodiments, more than one vacuum fan (224) can be used. The low-vacuum section (208) operates at low vacuum which is 6 inHg or less, e.g., ranging from about 1.5 to about 6 inHg.

In at least some embodiments, the vacuum box (216) may be of substantially the same construction as the vacuum box (232) described with reference to FIG. 2B. Specifically, the vacuum box (216) is a chamber for drawing water out the green ceiling basemat by suction established with the vacuum fan (224) generating negative pressure in the vacuum box (232) through the conduit (218) connecting the vacuum fan (224) to the vacuum outlet (312) in a sidewall of the vacuum box (216). As to the suction panel (318) which is in contact with the conveyor surface (203), the suction panel (318) may be the same as in the vacuum box (232), or it may be different. For example, slots (320) may be narrower and/or there may be fewer of them in the vacuum box (216), such that these vacuum boxes (216) of the low-vacuum section (208) generate only weak suction in order not to disturb a forming green ceiling basemat.

After moving through the low-vacuum section (208), the green ceiling basemat enters the high-vacuum section (210).

The high-vacuum section (210) comprises a first press (226), a second press (228) and a calendar (230), the second press (228) being positioned after the first press (226) and the calendar (230) being positioned after the second press (228), all relative to the machine direction.

In some embodiments, one vacuum box (232), designated as number 7 in FIG. 2A, may be positioned between the first press (226) and the second press (228), relative to the machine direction. However, this vacuum box (232) may optionally be operated in a closed-switch position in the method (100) such that no negative pressure is established in this vacuum box 7. The vacuum box 7 may not apply suction to a moving green ceiling basemat in some embodiments. In some embodiments, no vacuum box suction may be used between the first press (226) and the second press (228). This configuration is particularly useful when the available vacuum pump capacity of the process is limited, and/or multiple vacuum boxes share common vacuum pump/s, and/or a higher vacuum pressure (suction) is desired at the vacuum boxes subsequent to the vacuum box 7.

The high-vacuum section (210) is further equipped with additional vacuum boxes (232s), preferably 4 additional vacuum boxes (232s), denoted as vacuum boxes 8-11 in FIG. 2A, of which three vacuum boxes 8 through 10 are positioned consecutively to each other and after the second press (228), but before the calendar (230), relative to the machine direction, but more or fewer vacuum boxes (232s) can be also used.

These vacuum boxes 7-11 are operably connected by their vacuum outlets (312s) through switch-regulated conduits (236s) to a set of vacuum pumps (234), one embodiment of this assembly is shown in more detail in FIG. 4. The set of vacuum pumps (234) is configured to generate negative (lower than atmospheric) pressure in the vacuum box (232) such that water can be drawn out the green ceiling basemat.

Referring to FIG. 4, this is a schematic top-down cross-sectional view of one embodiment of the vacuum suction assembly according to this disclosure, generally (300). In FIG. 4, the assembly (300) includes three vacuum pumps (314s), but in other embodiments more or fewer vacuum pumps (314s), e.g. one, two, four or five pumps (314s), can be used. Each vacuum pump (314) has a conduit (316) opening into a joint conduit (310). The conduit (310) is also connected to switch-operated conduits (236s) which are connected through vacuum outlets (312) to vacuum boxes 7 through 11. When the switch (330) is in an open position, negative pressure is generated in the vacuum box (232) for which the switch (330) is open. The vacuum box (232) with the switch (330) in the open position can be referred to as the vacuum box (232) in an open position. When the switch (330) is in a closed position, no negative pressure is generated in the vacuum box (232) for which the switch (330) is closed even as the vacuum pumps (314s) may continue to generate negative pressure in other connected vacuum boxes which are in an open position. The vacuum box (232) with its switch (330) in the closed position can be referred to as the vacuum box (232) in a closed position.

In some preferred embodiments of the method (100), the seventh vacuum box (which is the vacuum box between the first (226) and the second (228) presses) and also the eighth vacuum box (which is the first vacuum box after the second press (228)) may be operated in their closed positions such that no vacuum suction is applied by the seventh vacuum box or the eight vacuum box to the green ceiling basemat. This configuration re-distributes the negative pressure between vacuum boxes 9 through 11 such that these vacuum boxes 9 through 11 apply a stronger vacuum suction while vacuum pumps (314s) can still operate in the range from about 7 to about 20 inHg.

In the first press (226), which in embodiments may be a twin-roll press with one of the rolls positioned over the conveyor surface (203) and the other roll being positioned under the conveyor surface (203) such that the green ceiling basemat is compressed to a first caliper between the first and the second roll of the first press (226). In the second press (228), which may be also a twin-roll press as the first press (226), the green ceiling basemat is further compressed to a second caliper, wherein this second caliper is the final caliper of the green ceiling basemat. Pressing to the final caliper in the second press (228) is technologically different from conventional methods in which the second press does not compress to the final caliper and instead, the final caliper is obtained only by a further compression with the calendar (230). In contrast to conventional methods, the calendar (230) operates at the same caliper as the second press (228) in the method (100), according to this disclosure.

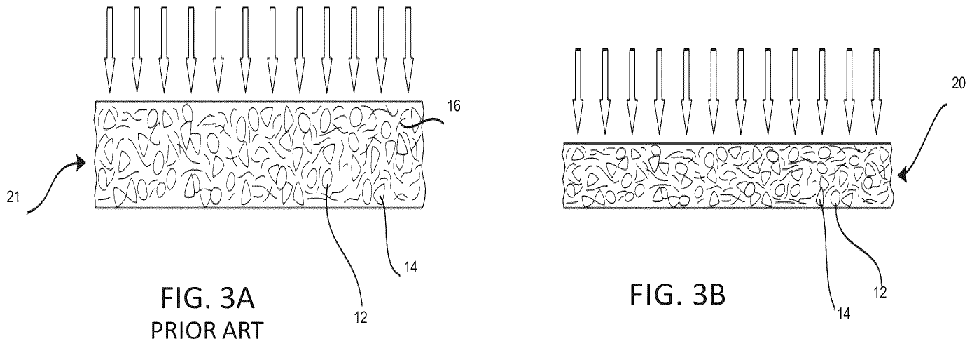

Referring to FIGS. 3A and 3B and without wishing to be bound by this theory, the inventors have determined that when the vacuum suction is applied between the first press (226) and the second press (228), as was conducted in conventional methods for example with vacuum box 7, the vacuum suction occurs when the green ceiling basemat (21) is still very porous, comprising a great number of air voids (12), and therefore, instead of drawing the water out first from the green ceiling basemat, the predominant portion of water is redistributed in the basement itself (21), while the air gets preferentially removed from the basemat, as shown in FIG. 3A. In contrast to FIG. 3A, when the present method (100) is performed as shown in FIG. 3B on the green ceiling basemat (20), compression takes place with the first press (226) and then with the second press (228). In a preferred embodiment, only after the final caliper has been obtained in the second press (228), vacuum suction is applied with the vacuum box 9. As most of the air was already removed by compression in the second press (228), water is now efficiently drawn out from the green ceiling basemat (20) according to this disclosure. In FIGS. 3A and 3B, a cross-sectional view of the control green ceiling basemat (21) and of the green ceiling basemat according to this disclosure (20) are shown. Also shown are the air voids (12), perlite particles (14) and fibers (16).

Thus, in the present method (100), the green ceiling basemat is more efficiently dewatered in the high-vacuum section (210), wherein after step (112), the green ceiling basemat is further smoothed with the calendar (230) operated at the same caliper as the second press (228). No additional change in caliper (thickness) of the green ceiling basemat takes place at the calendar (230) in at least some embodiments. After the calendar (230), the green ceiling basemat may be further suctioned with the vacuum box (232) positioned after the calendar (230), relative to the machine direction. In the embodiment of FIG. 2A, the vacuum box is referred as the 11^{th} vacuum box, but additional vacuum boxes over 11 can be also used.

In conventional methods, the water load of the green ceiling basemat after being processed in the high-vacuum section (210) is in the range of 1300-1550 lbs/MSF. It was unexpectedly found that the method (100) according to this disclosure produces the green ceiling basemat after being processed in the high-vacuum section (210) with a significantly reduced water load, which in embodiments may be less than 1250 pounds per one thousand square feet, preferably less than 1150 pounds per one thousand square feet, and most preferably less than 1050 pounds per one thousand square feet. In some embodiments of the present method (100), the water load on a dryer may be decreased by at least 5 wt %, at least 10 wt %, at least 15 wt %, at least 20 wt %, at least 20 wt %, at least 25 wt %, or at least 30 wt % in comparison to control methods in which a green ceiling basemat is not pressed to the final caliper in the second press (228).

The method (100) and the system (200) can be used for manufacturing a ceiling tile from an aqueous slurry which comprises fibers, perlite, a binder and optionally, one or more additives.

The slurry is water-based and may comprise from about 92 wt % to about 97 wt % water. The slurry is a suspension which may comprise about 3 wt % to about 8 wt % in total of components, including fibers, perlite, the binder and optionally some other additives. Examples of slurries for making ceiling tiles include, but are not limited to, U.S. Pat. Nos. 3,498,404; 5,047,120; 5,558,710; 5,964,934 and 10,696,594, the entire disclosure of which is herein incorporated by reference in its entirety.

Various fibers may be suitable, including without limitation, mineral wool, mineral fibers, glass fibers, cellulose (paper) fibers, plastic fibers, including polyvinyl chloride (PVC) fibers, or any combination thereof. Mineral wool or glass fibers may be used in any suitable amounts, including from about 10 to about 70 wt %, by weight of dry components. Cellulose fibers may be used in any suitable amounts, including from about 10 to about 20 wt %, by wight of dry components.

The second component in the slurries according to this disclosure is a binder, which is preferably a starch binder, preferably comprising potato starch, corn starch, and/or wheat starch, including as described in U.S. Pat. Nos. 5,911,818 and 5,964,934. As much as 15 wt %, more preferably from about 6 wt % to about 10 wt % may be a starch binder, by weight of dry components. Starch may be pre-gelatinized and/or it may be chemically modified, including acid-treated, alkaline-treated or enzyme-treated. Latex binders may be also used in addition to or instead of a starch binder. In embodiments, from about 1 wt % to about 9 wt % of a latex binder may be used, by weight of dry components. The latex binder may comprise a co-polymer of styrene and butadiene.

The slurry composition according to this disclosure may include perlite, expanded perlite, coated expanded perlite, gypsum, clay, calcium carbonate or any combination thereof. Clay can be used in small amounts, e.g. up to 5 wt % or less, preferably from about 0.1 wt % to about 5 wt %, by weight of dry components. Preferably, perlite may be expanded perlite. Perlite, preferably expanded perlite, may be used in any suitable amounts, for example from about 10 to about 70 wt %, by weight of dry components.

In some preferred embodiments, the ceiling tiles produced in the method (100), including by using the system (200), may include a finished ceiling tile which has a density of about 10 to about 20 pound per cubic foot (pcf), preferably about 10 to 15 pounds per cubic foot (pcf), and a thickness of about 0.5 inch to about 1 inch. The ceiling tiles of any dimensions can be produced in the methods according to this disclosure, including ceiling tiles 2 feet by 2 or 4 feet (2′×2′ or 2′×4′) and having a thickness from about 0.5 inch to about 1 inch.

The invention will now be further described with the following non-limiting example.

### Example 1

Green ceiling tile basemats were produced by the method (100) on the system (200). As a control, green ceiling tile basemats were produced on the system (200) by a convention method. The slurry contained mineral wool, perlite, a starch binder and paper fibers. All dry components were mixed as follows: perlite 63 wt %, mineral wool 10 wt %, starch 10 wt % and paper fibers 17 wt %. The resulting dry mixture was then mixed with water into a 4 wt % aqueous suspension and felted into a green ceiling basemat.

Results of these experiments are reported below in Tables 1 and 2.

It is found surprisingly that the water load of the green ceiling basemat can be significantly reduced by reducing the caliper targets at the 1^{st} (226) and the 2^{nd} (228) presses and achieving the final caliper at the 2^{nd} press (228), instead of the common practice of achieving the final caliper at the calendar press (230). Significant water load reduction was also achieved by shifting the vacuuming power more towards the later stage of the high vacuuming section. For example, vacuum boxes 7 and 8 as shown in FIG. 2A can be closed, so higher vacuuming pressure can be achieved in vacuum boxes 9, 10, and 11.

After vacuum boxes 7 and 8 were closed, a 7.9 wt % water load reduction was achieved, Table 1. The water load was measured by cutting a 5.25″ diameter cookie from the green base mat and measuring the weights of the cookie before and after being dried in the oven. The density of the dried and finished ceiling product ranged between 12.5 and 13 pcf.

With the vacuum boxes 7 and 8 being closed, the caliper targets at the 1st (226) and 2nd (228) presses were further lowered and the calendar caliper target was raised. The top roll at the calendar press (230) was not touching the green ceiling basemat after the change and the final basemat caliper was achieved at the 2nd press (228). By making these changes, an additional 5.0 wt % water load reduction was achieved, Table 2, in addition to the 7.9 wt % water load reduction achieved through closing the vacuum boxes 7 and 8. The total water load reduction was 12.9 wt %. This water load reduction was achieved without bringing in additional vacuuming power to the machine, such as installing an additional vacuum pump, and without lengthening the vacuuming time, such as slowing down the machine or installing additional vacuum boxes.

TABLE 1
Water Load Reduction Through Reallocation of
Vacuuming Power

| | | | | Caliper | Caliper |
|---|---|---|---|---|---|
| | | | | adjusted | adjusted |
| | | | | water | water |
| | Basemat | | Water | load, | load |
| | caliper, | % | load, | lbs/ | reduction, |
| Description | inch | Moisture | lbs/MSF | MSF | % |
| Control, all | 0.618 | 70.1 | 1389 | 1395 | — |
| vacuum boxes | | | | | |
| 7 through 11 | | | | | |
| are open | | | | | |
| Vacuum boxes | 0.612 | 68.0 | 1267 | 1284 | 7.9 |
| 7 and 8 closed | | | | | |

TABLE 2
Water Load Reduction Through Strategic Press Settings

| | | | | | | Caliper | Caliper |
|---|---|---|---|---|---|---|---|
| | | | Press caliper | | | adjusted | adjusted |
| | Press caliper | Press caliper | setting - | Basemat | Water | water | water |
| | setting - 1st | setting - 2nd | calendar press, | caliper, | load, | load, | load |
| Description | Press, inch* | Press, inch* | inch* | inch | lbs./MSF | lbs./MSF | reduction, % |
| Control, final | 0.5604 | 0.5279 | 0.4221 | 0.611 | 1284 | 1292 | — |
| caliper achieved at | | | | | | | |
| calendar (230) | | | | | | | |
| Trial, final caliper | 0.5450 | 0.5012 | 0.4735 | 0.608 | 1214 | 1228 | 5.0 |
| at the 2nd press | | | | | | | |
| (228) | | | | | | | |

*These press settings are relative positions and do not represent an absolute gap between the bottom of the press rolls and the top of the foraminous wire.

### Example 2

This example demonstrates reduction in water load observed for ceiling tile products with different formulations and thicknesses. In these experiments, vacuum box 7 of the system (200) was closed, caliper calendar (230) was completely disengaged, and caliper targets at the 1st (226) and 2nd (228) presses were lowered to obtain the final green basemat caliper at the 2^{nd} press (228).

TABLE 3
Water Load Reduction with Vacuum Box 7 Closed,
Caliper Calendar Disengaged, and Final
Basemat Caliper Achieved at the 2^{nd} Press

| | Product | Water load | Water load | Water |
|---|---|---|---|---|
| | thickness | before the | after the | load |
| | (caliper), | changes, | changes, | reduction, |
| Product | inches | lbs/MSF | lbs/MSF | % |
| Ceiling | 5/8″ | 1434 | 1050 | 26.8 |
| Basemat 1 | | | | |
| Ceiling | 5/8″ | 1342 | 1017 | 24.2 |
| Basemat 2 | | | | |
| Ceiling | 3/4″ | 1500 | 1214 | 19.1 |
| Basemat 3 | | | | |
| Ceiling | 3/4″ | 1535 | 1217 | 20.7 |
| Basemat 4 | | | | |

Ceiling basemat 1 was formed from an aqueous slurry prepared by mixing the following dry mixture with water to a 4 wt % slurry:
14 wt % mineral wool or glass fibers;
59 wt % expanded perlite;
10 wt % starch binder; and
17 wt % cellulose fibers.

Ceiling basemats 2 and 3 were formed from an aqueous slurry prepared by mixing the following dry mixture with water to a 4 wt % slurry:
40.5 wt % mineral wool or glass fibers;
31 wt % expanded perlite;
10.1 wt % starch binder;
16.4 wt % cellulose fibers; and
2.0 wt % clay.

Ceiling basemat 4 was formed from an aqueous slurry prepared by mixing the following dry mixture with water to a 4 wt % slurry:
60 wt % mineral wool or glass fibers;
14.7 wt % expanded perlite;
10.5 wt % starch binder; and
14.8 wt % cellulose fibers.

We claim:

1. A method for continuous manufacturing of a ceiling tile by a water-felting process, the method comprising:
a) felting an aqueous slurry comprising fibers, perlite, and a binder into a green ceiling basemat on a foraminous wire conveyor;
b) drawing water out the green ceiling basemat by free drainage;
c) after step b), drawing water out the green ceiling basemat by applying suction generated with one or more vacuum boxes operably connected to a vacuum fan;
d) after step c), compressing the green ceiling basemat with a first press to a first caliper;
e) after step d), compressing the green ceiling basemat with a second press to a second caliper, the second caliper being the final caliper for the green ceiling basemat;
f) after step e), drawing water out the green ceiling basemat by applying suction generated with one or more vacuum boxes operably connected to a set of vacuum pumps; and
g) drying the green ceiling basemat in a dryer.

2. The method of claim 1, wherein no vacuum box generated suction is applied to the green ceiling basemat between the first and second presses.

3. The method of claim 1, wherein the method further comprises calendaring the green ceiling basemat with a calendar wherein the calendar is set to the same caliper as the second press.

4. The method of claim 3, wherein the method further comprises drawing water out the green ceiling basemat by applying suction generated with one or more vacuum boxes operably connected to the set of vacuum pumps after calendaring.

5. The method of claim 1, wherein the green ceiling basemat after step f) has a reduced water load on the dryer in step g) in comparison to a control green ceiling basemat that was compressed to a final caliper with a calendar.

6. The method of claim 1, wherein the water load on the dryer is reduced by at least 5 wt %.

7. The method of claim 1, wherein the method further comprises:
after step f) and before step g), cutting the green ceiling basemat into master panels; and
after step g), cutting the master panels into ceiling tiles.

8. The method of claim 7, wherein the method further comprises: perforating, coating and/or laminating the ceiling tiles.

9. The method of claim 1, wherein step c) comprises passing the green ceiling basemat through at least six vacuum boxes operably connected to the vacuum fan.

10. The method of claim 1, wherein the final caliper of the green ceiling basemat ranges from about 0.5 to about 1.0 inches.

11. The method of claim 1, wherein the vacuum fan operates in a range of 1.5 to 6 inch mercury (inHg).

12. The method of claim 1, wherein the set of vacuum pumps operates in a range of 6 to 20 inch mercury (inHg).

13. The method of claim 1, wherein the set of vacuum pumps comprises two or three pumps.

14. The method of claim 1, wherein the slurry is a 3 to 8 wt % aqueous suspension.

15. A manufacturing system for performing the method of claim 1, wherein the system comprises:
a headbox for discharging a slurry;
a foraminous wire conveyor having a foraminous wire screen surface movable in a horizontal direction, the foraminous wire conveyor comprising:
i) a forming table;
ii) a free drainage section;
iii) a low-vacuum section comprising two or more vacuum boxes operably connected to a vacuum fan configured to lower pressure in the two or more vacuum boxes;
iv) a high-vacuum section comprising:
a first press and a second press positioned after the first press in the direction of the conveyor surface movement,
at least two vacuum boxes positioned consecutively after the second press, each of said vacuum boxes being sealed under the surface of the conveyor, wherein each of said vacuum boxes is operably connected to a set of vacuum pumps through a switch-regulated conduit, and
a dryer.

16. The manufacturing system of claim 15, wherein the manufacturing system further comprises a cutting knife section positioned after the high-vacuum section, relative to the direction of the conveyor surface movement.

17. The manufacturing system of claim 15, wherein the high-vacuum section comprises 3 to 5 vacuum boxes operably connected to the set of vacuum pumps.

18. The manufacturing system of claim 15, wherein the high-vacuum section of the manufacturing system further comprises a calendar with adjustable caliper; and a vacuum box positioned after the calendar relative to the direction of the conveyor surface movement, the vacuum box operably connected to the set of vacuum pumps.

19. A ceiling tile produced by the method of claim 1, wherein the green ceiling basemat has a water load on a dryer of less than 1250 pounds per one thousand square feet.
